(19) United States
(12) Patent Application Publication
(10) Pub. No.: US 2015/0303698 A1
(43) Pub. Date: Oct. 22, 2015

(54) SYSTEM AND METHOD FOR HOME AUTOMATION USING POWER INTERRUPTION AND DURATION

(71) Applicant: Frans Merilld, Hellerup (DK)

(72) Inventor: Frans Merilld, Hellerup (DK)

(21) Appl. No.: 14/692,373

(22) Filed: Apr. 21, 2015

Related U.S. Application Data
(60) Provisional application No. 61/982,792, filed on Apr. 22, 2014.

(51) Int. Cl. H02J 5/00

(52) U.S. Cl. CPC H02J 5/00

(57) ABSTRACT

The invention is a system and method for home automation that uses interruption of AC power to toggle a controlled device's on and off state, and its variable parameter settings.

### TECHNICAL FIELD

The present invention is a system and method for home automation.

### BACKGROUND OF THE INVENTION

The availability of a variety of handheld devices configured with applications that allow remote control of lighting and other household devices is having a profound effect on home automation. That said, though, existing wiring in many houses leave only the switched mains lines at ceiling embedded junction boxes and, in some cases, power outlets.

Wireless modules in conjunction with control modules can provide remote control of variable device parameters, such as light brightness and fan speeds. However, where such modules cannot be placed in a wall behind a switch, and, instead are located near the controlled device on a ceiling, it requires that either more lines be run from switch location to ceiling location to ensure that the interface between wall switch and control module is implemented.

Running additional lines from wall to ceiling and ensuring they are properly connected is both expensive and involves the services of electricians. Avoiding that cost by mounting a control module on the wall behind a switch often requires retrofitting the wall, which is also expensive and requires skilled help.

A system and method that could allow the placement of control and wireless modules to be located close to the controlled device, and not require having to run additional control lines, would make home automation less costly and easier to implement.

### BRIEF SUMMARY OF THE INVENTION

It is, therefore, an object of the present invention to provide a system and method which allows wireless automated control, and local control, of ceiling mounted devices without need for running additional control wiring from wall to ceiling. It would also allow wireless automated control of devices plugged into switched power outlets.

The system makes use of a timer and accumulator, plus a method for using the interruption of power and its interruption duration, to provide continued local and remote control of a ceiling devices parameters, such as light brightness and fan speed. Used in conjunction with a switched electrical outlet, it would provide the same control as for ceiling-mounted devices.

### BRIEF DESCRIPTIONS OF THE DRAWINGS

FIG. 1 depicts a conventional configuration of a ceiling device set up for remote control via a wireless module. In FIG. 1, the switch and control module are located near one another in the wall. Hence, the interface wiring between switch and control module is both short and confined to the wall location.

FIG. 2 depicts the same conventional configuration but where the control module is now located near the ceiling-mounted device. In this case, the interface wiring must be routed from wall to ceiling.

FIG. 3 depicts one embodiment of the invention whereby the accumulator/timer system, shown located near the ceiling-mounted device, makes use of power interruption and duration of interruption to enable the control module and wireless module without need of running additional interface lines from wall to ceiling.

FIG. 4 depicts another embodiment of the invention whereby a wall switch controls a power outlet (401), and making use of power interruption and duration, controls a device connected to that outlet via a mating plug (402). As shown the controlled device may be separate from the other invention subsystems, or contained within the controlled device (403).

### DETAILED DESCRIPTION OF THE INVENTION

In traditional housing, ceiling lighting and fans involve wall switches that turn power on and off to the ceiling-mounted lights and fans. As such, the power outtake on the ceiling typically has just two wires, one switched and one return that are connected to the utility mains supply.

Where home automation via wireless control is to be adopted, the control and wireless modules use DC power and wire interfaces. The DC power, in turn, is provided by AC/DC power converters which are connected to utility mains supplies.

A control module provides a means of varying the variable parameters of the ceiling mounted device. For example, a control module could make a ceiling light brighter or dimmer. Another type of module could increase or decrease fan speed. Another could be used to open or close a ceiling skylight, and so on.

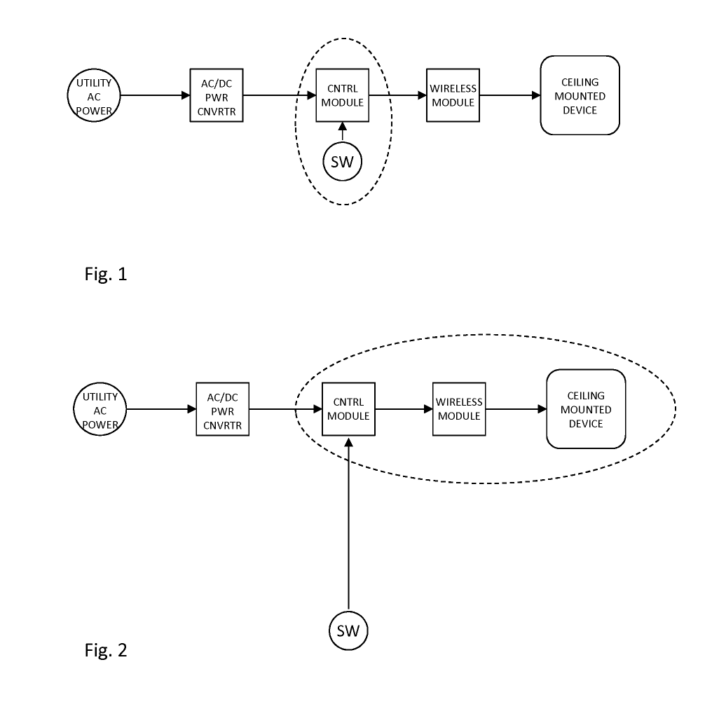

As shown in FIG. 1, utility mains AC power is converted to DC by a power converter and is routed to the control module. A switch turns the control module on or off. The control module's variable parameter state is routed by a wireless module to the ceiling-mounted device. Where the switch and control module are co-located in the wall, the interface between them is short and confined to the location.

FIG. 2 shows the same configuration but where the switch and control module are now separated, as for example, where the switch is wall mounted and the control module is ceiling mounted near the ceiling-mounted device. In that case, the interface between switch and control module requires wiring that is routed from wall to ceiling.

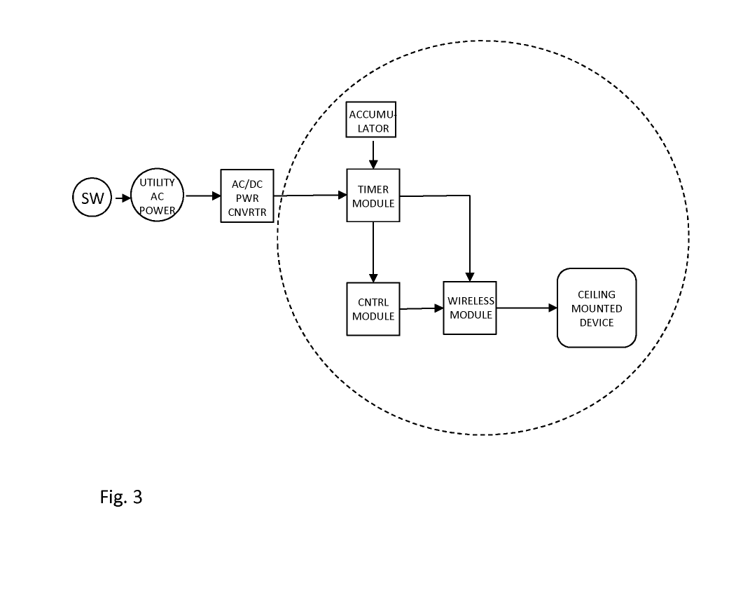

FIG. 3 shows an embodiment of the invention herein disclosed and claimed. In addition to the control and wireless modules, an accumulator and timer module have been added such that by switching the utility mains power off for a predetermined time and then back on, the on/off state of the ceiling-mounted device can be locally controlled, that is, by the wall switch. A second interruption in power for a different predetermined period of time initializes the control module to incrementally change device parameters from dim to bright, say, or slow to fast speed. The specific parameter setting is fixed by again interrupting the power for a predetermined amount of time.

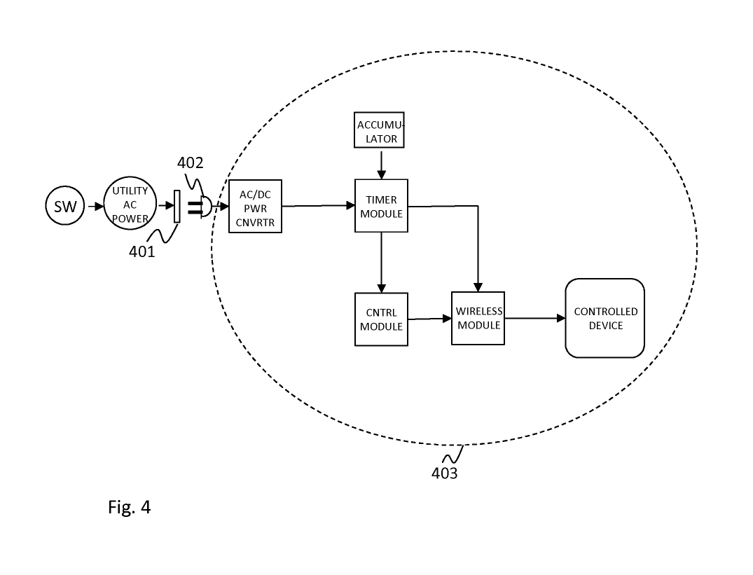

FIG. 4 shows another embodiment of the invention wherein the wall switch controls a power outlet, and a controlled device is connected to that power outlet. The controlled device will use all the same invention subsystems as in FIG. 3. However, these subsystems may be integrated with the controlled device such that, for example, a light source when screwed into a lamp's light-source socket, and the lamp's power cord connected to the switched power outlet, would enable control of the light source by switching the utility mains power off a for a predetermined time and then back on, as described in the previous paragraph. Thus, the invention is not confined solely to ceiling-mounted devices but could be used in controlling devices connected to switched power outlets, as well.

To contrast this system and method with a conventional configuration. If the switch in FIG. 1 or 2 was turned off, the power to the control module would be off. Therefore, the remote control would not be available. With the switch turned on, the light or fan would be also be on and remote control would be available.

Using the system of FIG. 3 or FIG. 4 and the power interruption and duration method disclosed, when the switch was turned off then on after a duration of a predetermined time, the system would be toggled on, say, and a repeated interruption for that predetermined amount of time would toggle it off, and so on. When toggled on, an interruption for a different predetermined duration would initialize the parameter control and set in motion a repeated incremental change in parameter until power was interrupted again for a different predetermined duration. That last interruption would set the parameter at its current level. Thus, the system provides local control without needing to route additional wire interface between the wall and ceiling; and can be used to control devices plugged into switched outlets, as in FIG. 4. The control is established by power interruption sequences instead. Also, with the power to the system in an on state, remote control can be used as with the conventional configuration, again, without requiring any control lines being routed from wall to ceiling.

What is claimed is:

1. A system for local and remote control comprising:
An AC power source;
An AC/DC converter subsystem;
A switch controlling delivery of said AC power to said AC/DC converter subsystem ;
A timer module;
An accumulator module;
A control module operative to vary one or a plurality of parameters of a controlled device;
A wireless module operative to receive wireless signals and respond to said wireless signals comprising by:
opening or closing a circuit;
changing a variable electrical characteristic;
transmitting a status signal.

2. A method for local and remote control comprising:
Enabling the interruption of said AC power to toggle said controlled device from an on state to an off state;
Enabling said interruption of said AC power to toggle said controlled device from a said off state to a said on state;
Enabling said interruption of said AC power to initiate a repeated sequence of incremental changes of said controlled device's parameters;
Enabling said interruption of said AC power to set a controlled device's parameters to the current value at the time of said interruption.
